(19) United States
(12) Patent Application Publication
(10) Pub. No.: US 2004/0160578 A1
(43) Pub. Date: Aug. 19, 2004

(54) OPTICAL SYSTEM FOR A PROJECTION DISPLAY

(76) Inventor: Ho Lu, Hsinchu (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,788

(22) Filed: Feb. 19, 2003

(51) Int. Cl. G03B 21/14

(52) U.S. Cl. 353/20

(57) ABSTRACT

An optical system for a projection display comprising a light source; an illumination module for receiving light from the light source; a prism assembly including a first prism pair consisting of a first prism and a second prism, and a second prism pair consisting of a third prism and a fourth prism, wherein a first dichroic mirror is provided in between the first prism and the second prism, and a second dichroic mirror is provided in between the third prism and the fourth prism, a polarizing beam splitter is provided in between the first prism pair and the second prism pair; a projection lens; and first to third reflective light valves for changing the polarity of light and for reflecting light to the prism assembly.

### BACKGROUND OF INVENTION

1. Field of the Invention

The present invention relates to a projection display, and more particularly to an optical system having reflective light valves for a projection display.

2. Description of the Related Art

In recent years, the importance of information visualization has been widely perceived and the need for projection displays has been increased rapidly. High projection quality, low production costs, and lightweight designs are the primary R&D objectives of the industry.

U.S. Pat. No. 5,777,789 to Chiu discloses an optical system consisting of reflective light valves, a polarizing beam splitter, color image combining prisms, an illumination system, and a screen. The primary disadvantages of this prior art optical system lie in that due to angular dependence of the polarizing beam splitter, in other words, for light beams incident on the polarizing beam splitter at different angles, the transmitted light beams are polarized in different directions and this can result in a serious problem of non-uniform contrast and a problem of low contrast; the optical system involves a long back focal length and this causes a problem of a projected image of low brightness or of the need for a big size projection lens; and the optical system involves a serious problem of birefringence that can affect projection quality thereof.

U.S. Pat. No. 5,826,959 to Atsuchi discloses an image projection apparatus consisting of three dichroic mirrors, three polarizing beam splitters, a plurality of reflective light valves, a cross dichroic prism device, an illumination system, and a screen. The primary disadvantages of this prior art image projection apparatus lie in that it includes too many elements that result in a complicated structure, high production costs, and a big size; and it involves a long back focal length and this causes a problem of a projected image of low brightness or of the need for a big size projection lens.

### SUMMARY OF INVENTION

An object of the invention is to provide an optical system for a projection display, wherein a prism assembly includes a polarizing beam splitter, e.g. a wire grid polarizer, involving no angular dependence instead of a conventional polarizing beam splitter involving angular dependence, thereby avoiding or mitigating the above-mentioned problem of non-uniform contrast and problem of low contrast.

Another object of the invention is to provide an optical system for a projection display, which involves no any long back focal length. Therefore, the above-mentioned low brightness problem of a projected image or of the need for a big size projection lens can be avoided or mitigated.

Still another object of the invention is to provide an optical system for a projection display, which has a unique geometrical structure that can help avoid or mitigate the above-mentioned problem of birefringence. Therefore, the projection quality can be improved.

Yet another object of the invention is to provide an optical system for a projection display, which is simple in structure and thereby can help avoid or mitigate the above-mentioned problems of high production costs and of a big size.

To achieve the above and other objects, the present invention provides an optical system for a projection display comprising a light source for providing light; an illumination module for receiving light from the light source and for outputting linear polarized white light; a color-selecting component for receiving said linear polarized white light and for selectively outputting first color light of a second polarity, second color light of a first polarity, and third color light of the second polarity; a prism assembly including a first prism pair consisting of a first prism and a second prism, and a second prism pair consisting of a third prism and a fourth prism, wherein a first dichroic mirror is provided in between the first prism and the second prism, and a second dichroic mirror is provided in between the third prism and the fourth prism, a polarizing beam splitter is provided in between the first prism pair and the second prism pair, the first dichroic mirror can separate the third color light apart from the first color light and the second color light, and the second dichroic mirror can recombine the third color light together with the first color light and the second color light, and the prism assembly receives the first color light of the second polarity, the second color light of the first polarity, and the third color light of the second polarity from the color-selecting component; a projection lens; and first to third reflective light valves for changing the polarity of the first color light, the second color light, and the third color light respectively and for reflecting the first color light, the second color light, and the third color light respectively to the prism assembly so that the first color light, the second color light, and the third color light can pass through the prism assembly and be irradiated into the projection lens.

### BRIEF DESCRIPTION OF DRAWINGS

The above and other objects, advantages, and features of the present invention will be understood from the following detailed description of the invention when considered in connection with the accompanying drawings below.

FIG. 1 is a schematic view showing an optical system for a projection display in accordance with a preferred embodiment of the invention.

FIG. 2 is a schematic view showing the imaging system in the optical system.

FIG. 3 is a schematic view showing other imaging system in the optical system.

FIG. 4 is a schematic view showing another imaging system in the optical system

### DETAILED DESCRIPTION

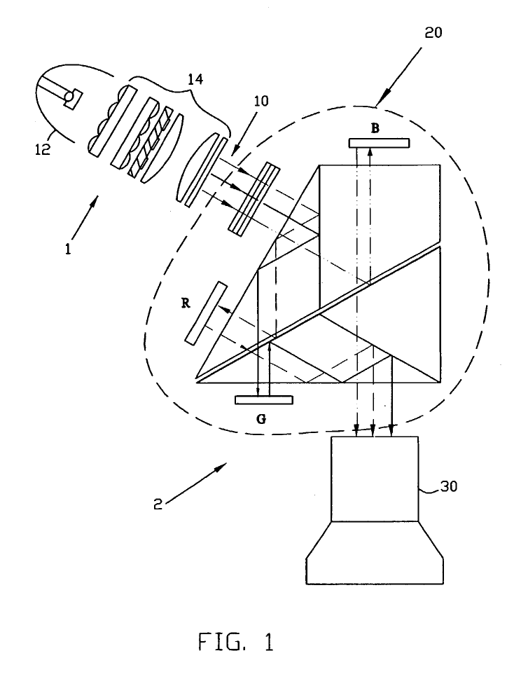

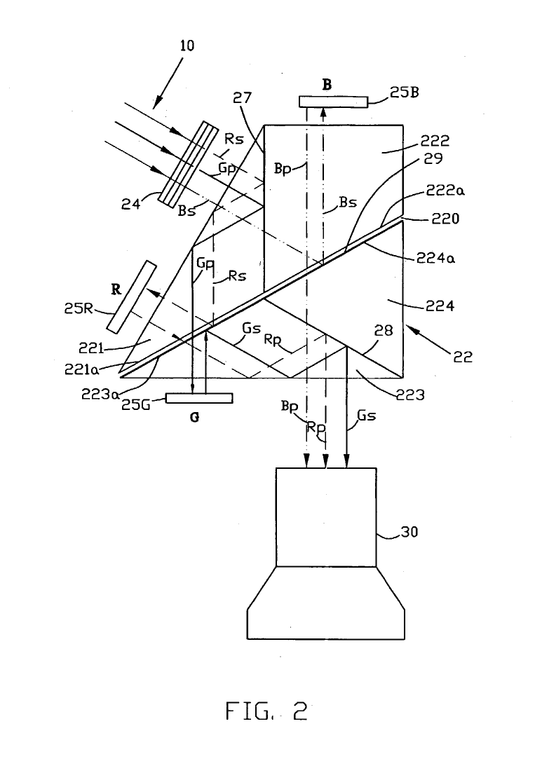

Referring to FIGS. 1 and 2, an optical system for a projection display in accordance with a preferred embodiment of the invention comprises an illumination system 1 and an imaging system 2. The illumination system 1 includes a light source 12 for providing light and an illumination module 14 for receiving light from the light source 12 and for outputting linear polarized white light 10.

The imaging system 2 comprises a color separating assembly 20 and a projection lens 30. The color separating assembly 20 comprises a prism assembly 22, a color-selecting component 24, and three reflective light valves 25R, 25G, and 25B. The reflective light valves 25R, 25G, and 25B can reflect red light, green light, and blue light respectively and change their polarity, i.e. change S-polarized light into P-polarized light and vice versa. In the present invention, referring to FIG. 2, P-polarized light means the vector of the electrical field of the electromagnetic wave thereof is parallel to the paper plane and perpendicular to the light rays of FIG. 2; S-polarized light means the vector of the electrical field of the electro-magnetic wave thereof is orthogonal to the paper plane of FIG. 2.

Referring to FIG. 2, the prism assembly 22 includes four prisms 221, 222, 223, and 224 made of, e.g., glass. The prisms 221 and 223 have similar shape and size, and the cross-sections thereof are isosceles triangles. Although, in this embodiment, the base angles of isosceles triangles are 30° for purposes of illustration, the base angles are not limited and preferably within in the range of about 15° to about 35°. The cross-section of the prism 222 is a trapezoid with a right base angle. The length of the base side of the trapezoid is the same as that of the adjacent side of the prism 221. The height of the prism 222 equals to a half of the length of the base side of the prism 223. A dichroic mirror 27 is provided in between the base side of the trapezoidal prism 222 and one of the two equal sides of the prism 221. The slant side of the trapezoidal prism 222 and the other of the two equal sides of the prism 221 are in the same line, as shown in FIG. 2, i.e. the side surface 221a of the prism 221 and the side surface 222a are in the same plane.

The cross-section of the prism 224 is an equilateral triangle. The length of any side thereof is equal to that of the adjacent side of the prism 223. A dichroic mirror 28 is provided in between the prism 224 and the prism 223. A side surface 223a of the prism 223 and a side surface 224a of the prism 224 are in the same plane. A wire grid polarizer 29 is provided on the side surface 223a and the side surface 224a. The wire grid polarizer 29 is spaced apart, by a small gap 220, from the side surface 221a and the side surface 222a, wherein the gap 220 is filled with air or the optical liquid, such as optical liquid, optical glue or gel, which has the refractive index close to the material of the prism assembly 22.

Both the dichroic mirror 27 and the dichroic mirror 28 transmit blue light and reflect red light and green light. The wire grid polarizer 29 transmits P-polarized light and reflects S-polarized light.

The color-selecting component 24 and the three reflective light valves 25R, 25G, and 25B are suitably positioned around the prism assembly 22, as shown in FIG. 2. Those skilled in the art can understand that the light paths of red light, green light, and blue light reflected by the reflective light valves 25R, 25G, and 25B, transmitted through the prism assembly 22, and irradiated into the projection lens 30 are preferably equal in length. The linear polarized white light 10 enters the color-selecting component 24 and the latter selectively outputs S-polarized red light Rs, P-polarized green light Gp, and S-polarized blue light Bs. The polarized trichromatic light hits the dichroic mirror 27 that transmits S-polarized blue light Bs and reflects S-polarized red light Rs and P-polarized green light Gp. Thereafter, S-polarized blue light Bs passes the surface 222a of the prism 222 and the gap 220, and hits the wire grid polarizer 29 that involves no angular dependence, is reflected and hits the reflective light valve 25B. The reflective light valve 25B reflects S-polarized blue light Bs and changes its polarity simultaneously so that S-polarized blue light Bs is changed into P-polarized blue light Bp that is then transmitted through the wire grid polarizer 29 and the dichroic mirror 28 and irradiated into the projection lens 30.

The above-mentioned S-polarized red light Rs reflected by the dichroic mirror 27 is totally reflected at the outer surface of the prism 221, is reflected on the wire grid polarizer 29, and then hits the reflective light valve 25R. The reflective light valve 25R reflects S-polarized red light Rs and changes its polarity simultaneously so that S-polarized red light Rs is reflected into P-polarized red light Rp that is then transmitted through the wire grid polarizer 29, totally reflected on the outer surface of the prism 223, reflected by the dichroic mirror 28, and irradiated into the projection lens 30.

The above-mentioned P-polarized green light Gp reflected by the dichroic mirror 27 is totally reflected at the outer surface of the prism 221, is transmitted through the wire grid polarizer 29, and then hits the reflective light valve 25G. The reflective light valve 25G reflects P-polarized green light Gp and changes its polarity simultaneously so that P-polarized green light Gp is reflected into S-polarized green light Gs that is then reflected from the wire grid polarizer 29, totally reflected on the outer surface of the prism 223, reflected by the dichroic mirror 28, and irradiated into the projection lens 30.

Due to that the wire grid polarizer 29 involves no angular dependence, all S-polarized light (orthogonal to the paper plane of FIG. 2) incident on the wire grid polarizer 29 at different angles involves no change in polarity when reflected therefrom, i.e. the vector of the electrical field of the electro-magnetic wave thereof is still orthogonal to the paper plane of FIG. 2; similarly, all P-polarized light (parallel to the paper plane and perpendicular to the light rays of FIG. 2) incident on the wire grid polarizer 29 at different angles involves no change in polarity when transmitted therethrough, i.e. the vector of the electrical field of the electro-magnetic wave thereof is still parallel to the paper plane and perpendicular to the light rays of FIG. 2. Thereby, the above-mentioned problem of non-uniform contrast and problem of low contrast can be avoided or mitigated.

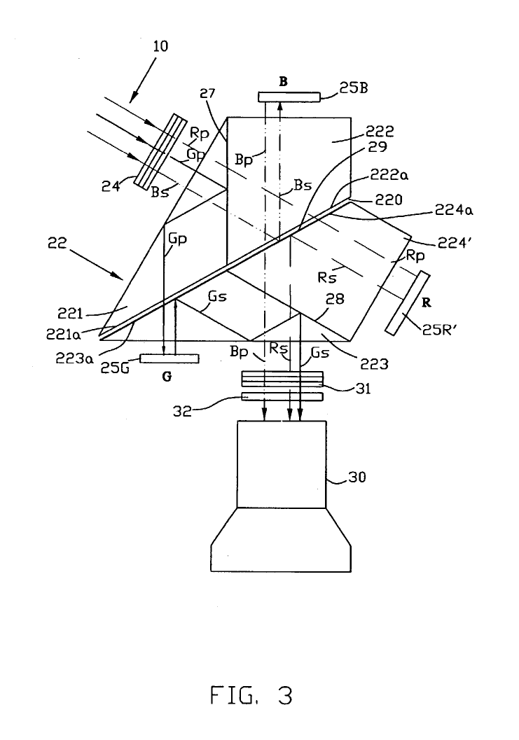

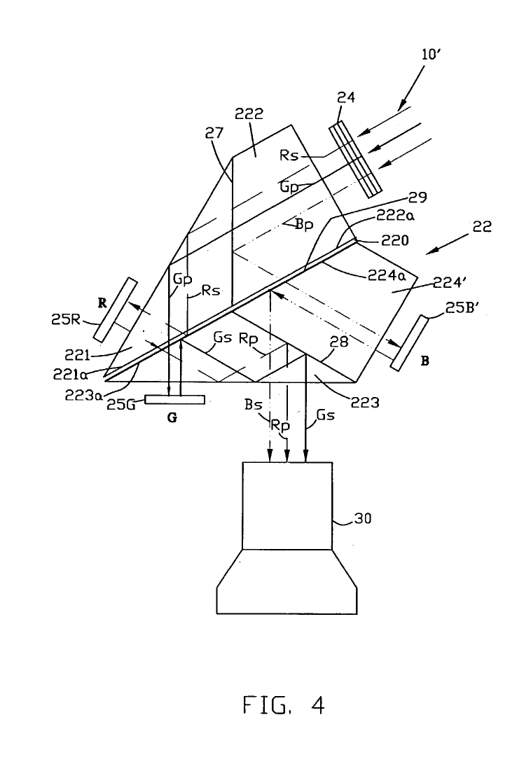

Referring to FIGS. 3 and 4, to achieve the flexibility of various alignments, the present invention also can replace the prism 224 by a prism 224′, and change the cross-section of the prism 224′ from an equilateral triangle to trapezoid with a right base angle. Therefore, the reflective light valves 25R can be moved to the position of the reflective light valves 25R′, or the white light 10 can be moved to the position of the white light 10′. Furthermore, a color-selecting component 31 and a polarizer 32 may be installed between the prism assembly 22 and the projection lens 30 to help purify color and polarized light.

While a preferred and particular embodiment of the present invention have been described herein for purposes of illustration, many modifications and changes will become apparent to those skilled in the art. For example, replacing the wire grid polarizer 29 by a conventional polarizing beam splitter, providing a color filter, a retardation film, or a color polarizer between each of the reflective light valves 25R, 25G, and 25B and the prism assembly 22 to help purify polarized light, providing an additional retardation film or color polarizer on the dichroic mirror 27 and the dichroic mirror 28 to help purify polarized light, and replacing the wire grid polarizer 29 by a double brightness enhanced film (DBEF) with trademark Vikuiti available from 3M all obviously fall within the true spirit and scope of this invention. Accordingly, the appended claims are intended to encompass all such modifications and changes as fall within the true spirit and scope of this invention.

What is claimed is:

1. An optical system for a projection display comprising:
a light source for providing light;
an illumination module for receiving light from the light source and for outputting linear polarized white light;
a color-selecting component for receiving said linear polarized white light and for selectively outputting first color light of a second polarity, second color light of a first polarity, and third color light of the second polarity;
a prism assembly including a first prism pair consisting of a first prism and a second prism, and a second prism pair consisting of a third prism and a fourth prism, wherein a first dichroic mirror is provided in between the first prism and the second prism, and a second dichroic mirror is provided in between the third prism and the fourth prism, a polarizing beam splitter is provided in between the first prism pair and the second prism pair, the first dichroic mirror can separate the third color light apart from the first color light and the second color light, and the second dichroic mirror can recombine the third color light together with the first color light and the second color light, and the prism assembly receives the first color light of the second polarity, the second color light of the first polarity, and the third color light of the second polarity from the color-selecting component;
a projection lens; and
first to third reflective light valves for changing the polarity of the first color light, the second color light, and the third color light respectively and for reflecting the first color light, the second color light, and the third color light respectively to the prism assembly so that the first color light, the second color light, and the third color light can pass through the prism assembly and be irradiated into the projection lens.

2. An optical system for a projection display according to claim 1, wherein the polarizing beam splitter substantially involves no angular dependence.

3. An optical system for a projection display according to claim 1, wherein the polarizing beam splitter is a wire grid polarizer.

4. An optical system for a projection display according to claim 1, wherein a small gap is formed in between the polarizing beam splitter and the first prism pair.

5. An optical system for a projection display according to claim 4, wherein the small gap is filled with the optical material which has the refractive index close to the material of the prism assembly.

6. An optical system for a projection display comprising:
a light source for providing light;
a color-selecting component for receiving light from the light source and for selectively outputting first color light of a second polarity, second color light of a first polarity, and third color light of the second polarity;
a prism assembly including first to fourth prisms, wherein a polarizing beam splitter substantially involving no angular dependence is provided on a side surface of the first prism, the polarizing beam splitter is adjacent to a side surface of the second prism, and the prism assembly receives, from the color-selecting component, the first color light of the second polarity, the second color light of the first polarity, and the third color light of the second polarity;
a projection lens; and
first to third reflective light valves for changing the polarity of the first color light, the second color light, and the third color light respectively and for reflecting the first color light, the second color light, and the third color light respectively to the prism assembly so that the first color light, the second color light, and the third color light can pass through the prism assembly and be irradiated into the projection lens.

7. An optical system for a projection display according to claim 6, wherein the polarizing beam splitter is a wire grid polarizer.

8. An optical system for a projection display comprising:
a light source for providing light;
a color-selecting component for receiving light from the light source and for selectively outputting first color light of a second polarity, second color light of a first polarity, and third color light of the second polarity;
a prism assembly including first to fourth prisms, wherein the first prism has a first side surface and a second side surface that are adjacent side surfaces and form an acute plane angle, a polarizing beam splitter is provided on the second side surface, and the prism assembly receives, from the color-selecting component, the first color light of the second polarity, the second color light of the first polarity, and the third color light of the second polarity;
a projection lens; and
first to third reflective light valves for changing the polarity of the first color light, the second color light, and the third color light respectively and for reflecting the first color light, the second color light, and the third color light respectively to the prism assembly so that the first color light, the second color light, and the third color light can pass through the prism assembly and be irradiated into the projection lens, wherein the first reflective light valve is adjacent to said first side surface.

9. An optical system for a projection display according to claim 8, wherein the acute plane angle is greater than or equal to 15°, and smaller than or equal to 35°.

10. An optical system for a projection display comprising:
a light source for providing light;
a color-selecting component for receiving light from the light source and for selectively outputting first color light of a second polarity, second color light of a first polarity, and third color light of the second polarity;
a prism assembly including first to fourth prisms extending in the same direction, wherein each of the first to fourth prisms has three or more side surfaces, a first spacing region is formed between the first side surface of the first prism and the second side surface of the second prism, a second spacing region is formed between the first side surface of the second prism and the second side surface of the third prism, a third spacing region is formed between the first side surface of the third prism and the second side surface of the fourth prism, a fourth spacing region is formed between the first side surface of the fourth prism and the second side surface of the first prism, a dichroic mirror is provided in each of the first and third spacing regions, a polarizing beam splitter is provided in each of the second and fourth spacing regions, and the prism assembly receives, from the color-selecting component, the first color light of the second polarity, the second color light of the first polarity, and the third color light of the second polarity;
a projection lens; and
first to third reflective light valves for changing the polarity of the first color light, the second color light, and the third color light respectively and for reflecting the first color light, the second color light, and the third color light respectively to the prism assembly so that the first color light, the second color light, and the third color light can pass through the prism assembly and be irradiated into the projection lens.

11. An optical system for a projection display according to claim 10, wherein the polarizing beam splitter substantially involves no angular dependence.

12. An optical system for a projection display according to claim 10, wherein the polarizing beam splitter is a wire grid polarizer.
